(19) United States
(12) Patent Application Publication
(10) Pub. No.: US 2007/0207436 A1
(43) Pub. Date: Sep. 6, 2007

(54) Orthodontic Appliance

(76) Inventors: Kok Liang Tan, Singapore (SG); Hong Meng Lim, Singapore (SG)

Correspondence Address: Albert Wai-Kit Chan;Law Offices of Albert Wai-Kit Chan, World Plaza, Suite 604, 141-07 20th Avenue, Whinestone, NY, 11357, US

(21) Appl. No.: 10/578,762

(22) PCT Filed: Nov. 7, 2003
(86) PCT No.: PCT/SG03/00259

§ 371 Date: Dec. 19, 2006

(51) Int. Cl. A61C 3/00

(52) U.S. Cl. 433/10

(57) ABSTRACT

The present invention relates to an orthodontic appliances, particularly a bracket, comprising a base portion adapted for bonding to a surface of a tooth, a body portion extending from the base portion and having an archwire receiving means having a first part (3) which has at least a first dimension substantially adapted to receive a portion of an archwire (4) and having a second part comprising a narrowing portion (2) having a second dimension substantially more narrow than the first dimension.

### FIELD OF THE INVENTION

The present invention relates to orthodontic appliances. In one form, the present invention relates to orthodontic brackets and/or buccal tubes for positioning on labial, buccal, occlusal and/or lingual surfaces of teeth.

### BACKGROUND OF THE INVENTION

Orthodontic tooth movement is a specialised branch of dentistry which is involved with the re-arrangement of crooked teeth into an aesthetic, functional and harmonious position relative to the rest of the face.

In comprehensive orthodontic treatment, orthodontic brackets are bonded to the surfaces of most or all of the teeth in the mouth. Orthodontic brackets can be bonded on the outside (labial or buccal) or the inside (lingual) surfaces of teeth. For braces bonded on the outside of teeth, patients generally prefer the brackets to be as small as possible so that it would appear less visible and hence pose less of an aesthetic problem to the wearer.

The orthodontic brackets tend to have rectangular slots that are open on one side to accept orthodontic archwires. For brackets bonded on the outside surfaces of teeth, the opening for each archwire slot is conventionally on the labial or buccal side. For brackets bonded on the inside surfaces of teeth, the opening for each archwire slot is either on the lingual or occlusal side.

One archwire is usually used for each jaw. The archwire may be round or rectangular in cross section and inserted into the slots of all the brackets in the same arch. For the molars or big posterior teeth, the archwire is usually passed through either brackets or tubes which are attached to the molars. The archwire ends at or behind the last molar tooth with appliance.

In order to effect tooth movement, the archwire must be securely held in the archwire slots so that orthodontic forces can be applied to the teeth in the arch. Orthodontic forces required to effect physiological tooth movement are typically 200 g or below per tooth. Excessive forces cause pain to the patient and can also retard tooth movement. For effective tooth movement the archwire should be free to move within the confines of the archwire slot.

Currently most orthodontists use ligatures to connect the archwire to the brackets and to push the archwire to seat within the archwire slots. One type of commercially available orthodontic ligature is a small elastomeric ring. This is made from polyurethane and is also known as a module or “O” ring. In use, the doctor stretches the elastomeric ring around the tiewings (legs connected to the bracket body) on both the gingival and occlusal aspects of the bracket. Once employed, the elastomeric ring extends around the tiewings as well as the labial aspect of the archwire thereby applying a seating force on the archwire towards the lingual wall of the archwire slot.

One disadvantage of this elastomeric ring is the tendency for force decay as the material absorbs moisture and stains. It also attracts bacterial plaque and can sometimes spontaneously dislodge from the bracket. The elastomeric ring when freshly installed also have a gripping force on the archwire thereby there is a tendency to increase friction between the archwire and the bracket. This is undesirable when optimum tooth movement is the objective.

Metal ligature can also be used to retain archwire in archwire slots of brackets. Metal ligatures are made from “dead soft” stainless steel wires of small diameters. During use, the wire ligature is hooked around the occlusal and gingival tiewings and over the labial side of the archwire. The ends of the ligature are then twisted and tightened around the tiewings of the brackets. Metal ligatures take a longer time to place as compared to elastomeric ligatures and can unravel in the patient's mouth during chewing, poking the soft tissues of the patient's mouth.

Both types of elastomeric and metal ligatures are considered time consuming to install and additional pliers are required for placement.

In order to overcome the problems associated with conventional ligatures there has been developed or proposed a variety of orthodontic brackets with various types of latches for coupling the archwire to the bracket. These brackets are commonly known as self-ligating brackets. These brackets use a form of latch to open and close the archwire slots. The latch comprises a clip, hook, spring member, cover, shutter, bail or other structure that is connected to the body of the bracket for the purpose of retaining the archwire in the archwire slot.

Some examples of self-ligating orthodontic brackets are described in U.S. Pat. Nos. 3,772,787, 4,248,588 and 4,492,573, disclosing U-shaped ligating latch clips, while U.S. Pat. Nos. 5,094,614, 5,322,435 and 5,613,850 disclose sliding closure latches. The opening and closing of the sliding closure latch is by means of a spring or a clamping release mechanism. Another type of self-ligating orthodontic bracket is cover-plate type latch, wherein the opening and closing of the cover-plate type latch is via a spring or a rotatable locking mechanism. U.S. Pat. Nos. 5,516,284, 5,685,711 and 5,711,666 disclose cover-plate type latches using spring mechanisms while U.S. Pat. Nos. 4,103,423, 4,371,337, 4,559,012 and 4,712,999, disclose cover-plate type latches using rotatable locking mechanisms. Other types of self-ligating orthodontic brackets using wire-like latches are disclosed in U.S. Pat. Nos. 4,149,314, 4,260,375, 4,725,229 and 5,269,681.

All types of currently available self-ligating brackets are considered similar in one way. All self-ligating brackets have a small movable part of the bracket that is positioned in open slot position to accept an archwire and then moves to a closed slot position to contain or lock the archwire. To remove the archwire from the bracket, the movable part has to be returned to the open slot position.

For the orthodontist the procedure to remove and insert the archwire involves the use of additional instruments to move the movable part of the self-ligating bracket from open slot to close slot and vice versa. This can be fiddly and can also pose a problem to orthodontists who are sight challenged as the movable parts are always relatively small in size.

A recent U.S. Pat. No. 6,582,226 B2 discloses an orthodontic appliance with a self-releasing latch. The latch, includes at least one arm portion, is connected to the body and moves relative to the body of the bracket to either open the archwire slot to accept an archwire or close the slot to release an archwire. The arm portion is secured to the body of the bracket by means of welding or brazing, by an adhesive, by fasteners or by any other suitable means. The arm portion may disconnect from the body during use or in-used. Hence, there is a high risk of inhalation or swallowing of the arm portion by the patient, if the arm portion becomes disconnected.

In summary, there are considered 2 main disadvantages with regard to the currently available types of self-ligating and self-releasing brackets.

Firstly, in the course of orthodontic treatment archwires need to be placed and replaced at regular intervals in the archwire slots. The repeated gross movements of tiny movable parts of the brackets (either connected or separate) relative to the main bodies of the brackets is undesirable as fatigue is likely to set in, resulting in microfractures or breakages with the attendant risk of inhalation or swallowing of small parts of bracket material by the patient. This can be potentially catastrophic and the risk although relatively small may be life threatening to the patient.

Secondly, all existing bracket systems whether conventional, self-ligating or self-releasing have slots with occlusal and gingival sides which are rigid and immovable relative to each other. With severely malpositioned teeth, the roots of such teeth are frequently far away from the ideal positions. To align such teeth, both the roots and crowns must be moved to the correct position. Root movement in such cases is necessary for stability of the corrected crown position. To move the roots of such malpositioned teeth a long distance, rectangular archwires with twisting forces (torque forces) are required in rectangular archwire slots. When such a rectangular wire is first inserted into the archwire slot of a severely malpositioned tooth, the wire must be forcibly positioned into the slot. Such forces are always in excess of usual orthodontic forces and pain and discomfort are experienced by the patient when the gingival and occlusal sides are rigid and immovable.

Any discussion of documents, devices, acts or knowledge in this specification is included to explain the context of the invention. It should not be taken as an admission that any of the material forms a part of the prior art base or the common general knowledge in the relevant art in Singapore or elsewhere on or before the priority date of the disclosure and claims herein.

An object of the present invention is to provide an improved orthodontic appliance.

A further object of the present invention is to alleviate at least one disadvantage associated with the prior art.

### SUMMARY OF THE INVENTION

The present invention provides, in one aspect, an orthodontic appliance comprising a base portion adapted for bonding to a surface of a tooth, a body portion extending from the base portion and having an archwire receiving means, the archwire receiving means having a first part which has at least a first dimension substantially adapted to receive a portion of the archwire and having a second part comprising a narrowing portion having a second dimension substantially more narrow than the first dimension.

The present invention also provides, in another aspect, a kinematic inversion of the aspect above, in which the orthodontic appliance comprises a base portion adapted for bonding to a surface of a tooth, a body portion extending from the base portion and having an archwire receiving means, the archwire receiving means having a first part which has at least a first dimension substantially adapted to receive a portion of the archwire and having a second part comprising an enlarged portion having a second dimension substantially greater than the first dimension.

The present invention provides, in a further aspect, a method of coupling an archwire to an orthodontic appliance, the method comprising the steps of bonding a base portion of the appliance to a surface of a tooth, placing the archwire proximate an archwire receiving means, and moving the archwire into contact with either a narrowing portion of the archwire receiving means or an enlarged portion of the receiving means.

Other aspects and preferred aspects are disclosed in the specification and/or defined in the appended claims, forming a part of the description of the invention.

In essence, the present invention stems from the desire to provide an orthodontic appliance with a design which is able to accept an orthodontic archwire in which insertion and removal do not require a separate step of ligation. In this regard, the present invention is directed towards an orthodontic appliance, such as a bracket or buccal tube, having features that represent significant advantages over currently available self-ligating or self-releasing appliances. The body portion and the archwire receiving means of the present appliance is constructed in one piece, is simple to make and even simpler to use as compared to all existing orthodontic appliances. Essentially a no ligation system is used that obviates the need for a separate step (usually also with separate instruments) to insert and remove archwires from archwire slots of orthodontic appliances. The present invention unlike all self-ligating or self-releasing systems does not require tiny movable parts as tiny movable parts may fail with prolonged usage in the oral cavity.

In the present invention, the ‘narrowing’ referred to may be rendered a number of ways or in combination with a lobe, projection, knob, ledge, ridge, boss, extension, flange, hump, lump, lip, nib, protrusion, ramp, rib, skirt, tongue, wedge or the like.

The present invention should not be limited to only the embodiment disclosed. For example, as is contemplated in the present invention, the ‘narrowing’ may be formed in the archwire, and/or be a kinematic inversion of the embodiment disclosed herein for illustrative purposes only. Likewise, the ‘narrowing’ may be formed by a combination of features of the appliance and the archwire.

The present invention has been found to result in a number of advantages, such as:
no tiny movable parts,
ease of insertion and removal of archwire without the need of additional instruments to move the movable part of the bracket from open to close position and vice versa and
simple to make as the body portion and the archwire receiving means of the orthodontic appliance is constructed in one piece.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 illustrates a side elevation view of an orthodontic appliance of the present invention,

FIG. 2 illustrates a front elevation view of the orthodontic appliance of FIG. 1,

FIG. 3 illustrates a side elevation view of another embodiment of an orthodontic appliance,

FIG. 4 illustrates a front elevation view of the orthodontic appliance of FIG. 3,

FIG. 5 illustrates a side elevation view of the orthodontic appliance, in use, and

FIG. 6 illustrates a side elevation view of the orthodontic appliance, in use when a large torque force is applied.

### DETAILED DESCRIPTION OF THE INVENTION

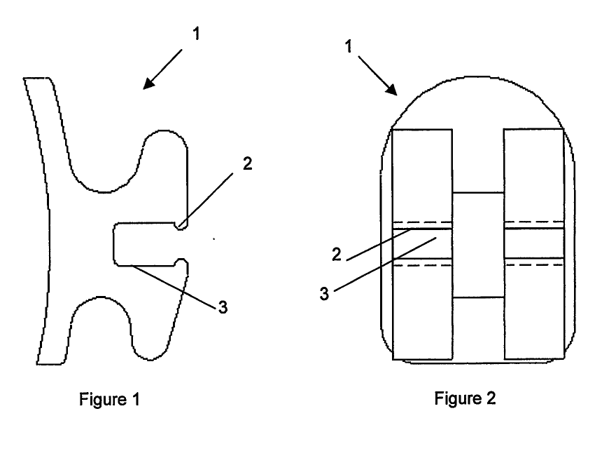

Referring to FIGS. 1 and 2, the side and front elevation view of one embodiment of the present invention are shown. It can be seen that the present invention provides an orthodontic appliance, such as a bracket 1 which has an integrally formed narrowing 2 proximate archwire slot 3. The narrowing 2 may be provided as strip substantially proximate the length of the slot 3, and/or may be provided only at one or more points proximate the slot 3. The narrowing 2 may also be providing a one or more points or sections along the depth of the slot 3.

In accordance with the present invention, the extent of narrowing may be used to determine the force(s) needed to install in, remove from and/or adjust an archwire in the appliance slot.

The present invention also provides, in another aspect, a kinematic inversion of the aspect above, in which the orthodontic appliance has an integrally formed enlarged portion proximate archwire slot. The enlarged portion may be provided as strip substantially proximate the length of the slot, and/or may be provided only at one or more points proximate the slot. The enlarged portion may also be providing a one or more points or sections along the depth of the slot.

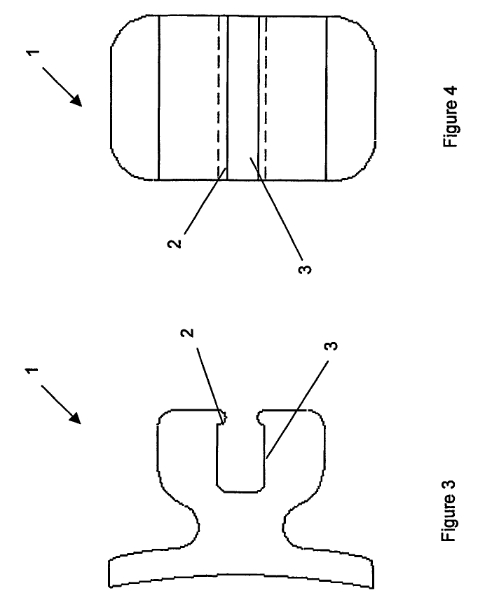

Referring to FIGS. 3 and 4, the side and front elevation view of another embodiment of the present invention are shown. Because there are no elastomeric or metal ligatures required for the present appliance, in use, no tie wings are required and the design of the appliance can be simplified and made smaller for maximum patient comfort. In this present invention, orthodontic appliances can be smaller, more aesthetic and more comfortable with absolutely no sharp edges, as shown in FIGS. 3 and 4. When in use, the present orthodontic appliances are further away from occlusal or biting forces from opposing jaw, as the present orthodontic appliances are vertically smaller compared with other conventional orthodontic brackets.

It can be seen, advantageously that the present invention has substantially no moving parts, and thus avoids many of the disadvantages associated with the prior art.

In the system of the present invention, the force to insert or remove the archwire is designed to be below the force that bonds the bracket to the tooth which is usually in excess of 50N. It is however above the force that is normally required to effect tooth movements such as tipping, intrusion, extrusion, rotation and bodily movements. Normal orthodontic forces are usually below 200 gf per tooth. The preferred force to insert or remove the archwire is below 2.5 kgf. The force to remove the archwire from the archwire slot is preferably less than half of that required to pull the bracket away from the tooth and therefore the integrity of the bracket with respect to the tooth it is bonded to will not be compromised.

The force required to insert the archwire is ideally above that to effect tooth movement and is approximately between 1 to 2.5 kgf.

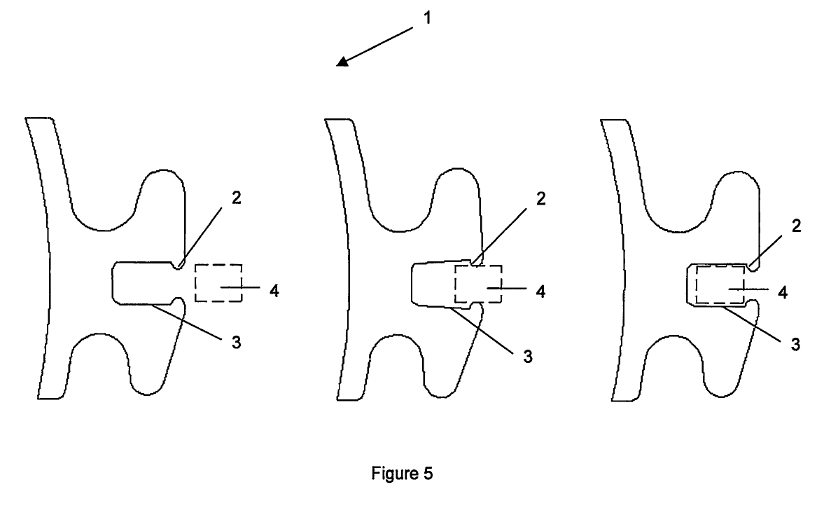

Referring to FIG. 5, after an appliance according to the present invention is bonded to the tooth, the orthodontist proceeds to select an appropriate archwire 4 and pushes the archwire 4 through the narrowing 2 of the present invention and into the archwire slot 3 digitally with a force of approximately 1 to 2.5 kgf. Preferably, the narrowing is formed proximate the gingival and occlusal sides of the archwire slot and in installing the archwire they will become more distal with respect to each other on application of force at the entrance of the archwire slot in the direction towards the bracket. When the archwire is fully inside the slot, the force to open the bracket is removed and the gingival and occlusal sides of the archwire slot will revert to the previously passive state, and in one form, parallel to each other.

To remove the archwire again a force of about 1 to 2.5 kgf is applied digitally through the archwire and away from the archwire slot. Again the narrowing of the present invention preferably proximate normally parallel gingival and occlusal sides of the archwire slot will become more distal to allow the exit of the said archwire.

The procedure for insertion and removal of archwire can be easily done by the orthodontist without the need for additional opening and closing instruments.

There are no tiny movable latches in the present invention, therefore the structural integrity of the appliance of the present invention is maintained.

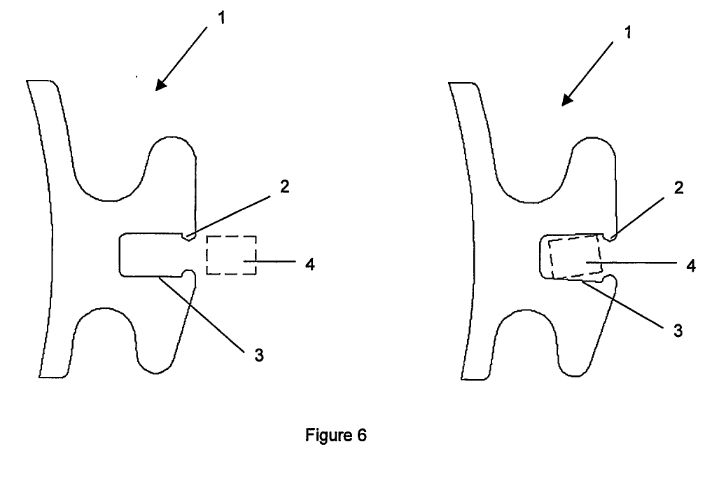

Referring to FIG. 6, when a large torque force is needed to speedily correct, for example, severely malpositioned teeth, the substantially elastic nature of the narrowing of the present invention, for example proximate the gingival/occlusal sides of the archwire slots ensure that such forces are partially cushioned by the bracket system thereby moderating the high force levels. This has been found to reduce patient's pain and discomfort while ensuring a near constant and optimum force level for tooth movement.

The material that can be used to construct the present appliance may be a metal or alloy with a high modulus of elasticity, a plastic or a polymer or a ceramic material.

While this invention has been described in connection with specific embodiments thereof, it will be understood that it is capable of further modification(s). This application is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

“Comprises/comprising” when used in this specification is taken to specify the presence of stated features, integers, steps or components but does not preclude the presence or addition of one or more other features, integers, steps, components or groups thereof.”

1. An orthodontic appliance comprising:
a base portion adapted for bonding to a surface of a tooth,
a body portion extending from the base portion and having an archwire receiving means,
the archwire receiving means having a first part which has at least a first dimension substantially adapted to receive a portion of the archwire and having a second part comprising a narrowing portion having a second dimension substantially more narrow than the first dimension.

2. An orthodontic appliance as claimed in claim 1, wherein the narrowing portion is provided along a length and/or depth of the archwire receiving means.

3. An orthodontic appliance as claimed in claim 1 or 2, wherein the narrowing is one or more points along a length and/or depth of the archwire receiving means.

4. An orthodontic appliance as claimed in any one of the preceding claims wherein the narrowing portion is at least one protrusion or rib.

5. An orthodontic appliance comprising:
a base portion adapted for bonding to a surface of a tooth,
a body portion extending from the base portion and having an archwire receiving means,
the archwire receiving means having a first part which has at least a first dimension substantially adapted to receive a portion of the archwire and having a second part comprising an enlarged portion having a second dimension substantially greater than the first dimension.

6. An orthodontic appliance as claimed in any one of the preceding claims, wherein the archwire receiving means is a slot provided in the body portion.

7. An orthodontic appliance as claimed in claim 5 or 6, wherein the enlarged portion is provided along a length and/or depth of the archwire receiving means.

8. An orthodontic appliance as claimed in claim 5, 6 or 7, wherein the enlarged portion is provided as one or more points along a length and/or depth of the archwire receiving means.

9. An orthodontic appliance as claimed in any one of claims 5 to 8, wherein the enlarged portion is at least one protrusion or rib.

10. An orthodontic appliance as claimed in any one of the preceding claims, wherein the appliance is an orthodontic bracket.

11. A method of coupling an archwire to an orthodontic appliance, the method comprising the steps of:
bonding a base portion of the appliance to a surface of a tooth,
placing the archwire proximate an archwire receiving means, and
moving the archwire into contact with either a narrowing portion of the archwire receiving means or an enlarged portion of the receiving means.

12. A method as claimed in claim 11, comprising the further step of moving the archwire substantially past the narrowing portion.

13. A method as claimed in claim 11 or 12, wherein the orthodontic appliance is an appliance as claimed in any one of claims 1 to 10.

14. An appliance substantially as herein disclosed.

15. A method substantially as herein disclosed.
